(19) United States
(12) Patent Application Publication
(10) Pub. No.: US 2026/0179902 A1
(43) Pub. Date: Jun. 25, 2026

(54) METHOD OF MANUFACTURING DRY ELECTRODE AND BATTERY MANUFACTURED THEREBY

(71) Applicants: Hyundai Motor Company, Seoul (KR); Kia Corporation, Seoul (KR)

(72) Inventors: Han Nah SONG, Hwaseong-si (KR); Hyun Mook HWANG, Hwaseong-si (KR); Yong Il CHO, Hwaseong-si (KR); Young Soo LEE, Hwaseong-si (KR)

(21) Appl. No.: 19/247,182

(22) Filed: Jun. 24, 2025

(30) Foreign Application Priority Data
Dec. 23, 2024 (KR) 1020240193908

(51) Int. Cl. H01M 4/04; G01Q 60/30

(52) U.S. Cl. CPC H01M 4/0416; G01Q 60/30; H01M 4/0435

(57) ABSTRACT

A method for evaluating a dry electrode mixture includes applying vibration to the dry electrode mixture for a predetermined time, and determining a dispersibility of the dry electrode mixture based on an analysis of the dry electrode mixture to which the vibration has been applied. For example, the analysis includes analyzing at least one of a color of the dry electrode mixture, a scanning electrode microscope image of the dry electrode mixture, an electrical conductivity of the dry electrode mixture, a content of the dry electrode mixture, or a combination thereof.

### CROSS-REFERENCE TO RELATED APPLICATION

This application claims under 35 U.S.C. § 119 (a) the benefit of priority from Korean Patent Application No. 10-2024-0193908, filed on Dec. 23, 2024, the entire contents of which are incorporated herein by reference.

### TECHNICAL FIELD

The present disclosure relates to a dry electrode for batteries.

### BACKGROUND

Rechargeable secondary batteries may be applied to various fields from small electronic devices to large energy storage systems. For example, secondary batteries may be used for electric vehicles.

Electrodes of secondary batteries may be manufactured through a wet process. In the wet process, an electrode active material, a binder, and a conductive material included in an electrode are dispersed in a solvent to prepare a slurry. In some cases, a dry process without using the solvent may be used to increase the energy density of a battery.

In the dry process of the electrode, a mixture is prepared by mixing an electrode active material, a conductive material, and a binder without a solvent, and then, a dry electrode film is formed from the mixture by pressing or calendering. In some cases, the manufacture of the electrode may be completed by bonding the dry electrode film to a current collector. In some cases, the powder mixture may be uniformly applied to a metal substrate and pressed to manufacture an electrode in a coated form.

Compared to the wet electrode manufacturing process, the dry electrode manufacturing process does not use a solvent so that factory layout and energy costs may be reduced. The dry electrode manufacturing process may be advantageous to electrode thickening and thus facilitate thickness control so that a dry electrode film having a high energy density may be obtained.

Unlike the wet process in which the binder is dissolved, the dry electrode goes through a process of mixing the conductive agent and the binder with the electrode active material in a powder state, and thus, it may be difficult to secure dispersibility. When manufacturing a thick dry electrode having a high energy density, movement paths of lithium ions and electrons become longer, so it may be important to secure dispersibility of the conductive material and the binder in the power mixing process.

### SUMMARY

The present disclosure describes a method for evaluating a dry electrode mixture that secures a quality of a dry electrode and uniform battery performance over the entire surface of the dry electrode by evaluating a dispersibility of the dry electrode mixture regardless of time, and a method of manufacturing a dry electrode including the same. For example, the dispersibility can be a value corresponding to at least one of a color difference, a conductivity difference, or a content difference between height levels in the dry electrode mixture that are formed by applying vibration to the dry electrode mixture in a container. In some cases, the dispersibility can be classified into an appropriate dispersibility and inappropriate dispersibility based on a predetermined dispersibility reference.

According to one aspect of the subject matter described in this application, a method for evaluating a dry electrode mixture includes applying vibration to the dry electrode mixture for a predetermined time, and determining a dispersibility of the dry electrode mixture based on an analysis of the dry electrode mixture after applying the vibration to the dry electrode mixture.

Implementations according to this aspect can include one or more of the following features. For example, determining the dispersibility includes, based on presence of a color difference between height levels in the dry electrode mixture formed after applying the vibration to the dry electrode mixture, determining that the dispersibility of the dry electrode mixture does not satisfy a predetermined standard. In some examples, applying the vibration to the dry electrode mixture can include applying the vibration to the dry electrode mixture until the dry electrode mixture is divided into two or more layers, where the dispersibility of the dry electrode mixture can be determined based on a comparison between the two or more layers of the dry electrode mixture.

In some implementations, the method can include providing the dry electrode mixture divided into the two or more layers through a mass flow feeder. In some examples, determining the dispersibility can include obtaining scanning electron microscope images of the two or more layers, and determining the dispersibility of the dry electrode mixture based on the scanning electron microscope images. In some examples, determining the dispersibility can include determining a size of a binder of the dry electrode mixture in the scanning electron microscope images, and based on determining that the size of the binder of the dry electrode mixture is greater than a predetermined size, determining that the dispersibility of the dry electrode mixture does not satisfy a predetermined standard.

In some implementations, determining the dispersibility can include measuring electrical conductivities of the two or more layers, and determining the dispersibility of the dry electrode mixture based on the measured electrical conductivities of the two or more layers. In some examples, determining the dispersibility can include, based on determining that a difference between the measured electrical conductivities of the two or more layers is greater than or equal to a predetermined value, determining that the dispersibility of the dry electrode mixture does not satisfy a predetermined standard.

In some implementations, determining the dispersibility can include determining contents of the dry electrode mixture in the two or more layers, and determining the dispersibility of the dry electrode mixture based on a comparison between the contents of the dry electrode mixture in the two or more layers. In some examples, determining the dispersibility can include, based on determining that the contents of the dry electrode mixture in any one of the two or more layers is not within a set range of a predetermined target content, determining that the dispersibility of the dry electrode mixture does not satisfy a predetermined standard. In some examples, determining the contents of the dry electrode mixture can include performing thermogravimetric analysis (TGA), carbon/sulfur determinator (CS) analysis, or combustion ion chromatography. In some examples, determining the contents of the dry electrode mixture can include determining a content of a binder or a conductive material in the dry electrode mixture.

In some implementations, the method can include, before applying the vibration to the dry electrode mixture, providing the dry electrode mixture to a plurality of sieves having different mesh sizes, where applying the vibration to the dry electrode mixture can include applying the vibration to the plurality of sieves.

In some implementations, the method can include, before applying the vibration to the dry electrode mixture, preparing the dry electrode mixture by mixing a dry electrode active material, a conductive material, and a binder.

In some implementations, the method can include, based on determining that the dispersibility of the dry electrode mixture satisfies a predetermined standard, forming the dry electrode mixture into a dry electrode film.

According to another aspect, a method for manufacturing a dry electrode includes preparing a dry electrode mixture, applying vibration to the dry electrode mixture for a predetermined time, determining a dispersibility of the dry electrode mixture based on an analysis of the dry electrode mixture after applying the vibration to the dry electrode mixture, and based on determining that the dispersibility of the dry electrode mixture satisfies a predetermined standard, forming the dry electrode mixture into a dry electrode film.

Implementations according to this aspect can include one or more of the following features. For example, determining the dispersibility can include analyzing at least one of a color of the dry electrode mixture, a scanning electrode microscope image of the dry electrode mixture, an electrical conductivity of the dry electrode mixture, a content of the dry electrode mixture, or a combination thereof.

In some implementations, applying the vibration to the dry electrode mixture can include applying the vibration to the dry electrode mixture until the dry electrode mixture is divided into two or more layers, where the dispersibility of the dry electrode mixture can be determined based on a comparison between the two or more layers of the dry electrode mixture.

In some examples, the dry electrode can be manufactured by the methods described above. In some examples, a battery can include the dry electrode manufactured by the methods described above.

### BRIEF DESCRIPTION OF THE DRAWINGS

The above and other features of the present disclosure will now be described in detail with reference to some example implementations thereof illustrated in the accompanying drawings which are given hereinbelow by way of illustration only, and thus are not limitative of the present disclosure.

FIG. 1 illustrates an example of a dry electrode manufacturing system.

FIG. 2 is a flowchart illustrating an example process for evaluating a dry electrode mixture.

FIGS. 3A-3F illustrate an example process for evaluating the dry electrode mixture.

FIG. 4 illustrates an example of a circle feeder configured to be used to evaluate the dry electrode mixture.

FIG. 5 illustrates an example of a screw feeder configured to be used to evaluate the dry electrode mixture.

FIG. 6 illustrates an example of sieves configured to be used to evaluate the dry electrode mixture.

FIG. 7 is an example of a scanning electron microscope image of a dry electrode mixture sample determined to have a poor dispersibility by the dry electrode mixture evaluation method. and

FIG. 8 is an example of a scanning electron microscope image of a dry electrode mixture sample determined to have a satisfactory dispersibility by the dry electrode mixture evaluation method.

### DETAILED DESCRIPTION

Specific structural or functional descriptions set forth in implementations of the present disclosure will be merely exemplarily given to describe the implementations depending on the concept of the present disclosure, and the implementations depending on the concept of the present disclosure can be embodied in different forms. Further, it will be understood that the present disclosure should not be construed as being limited to the implementations set forth herein, and the implementations of the present disclosure are provided only to completely disclose the disclosure and cover modifications, equivalents or alternatives which come within the scope and technical range of the disclosure.

Hereinafter, the present disclosure will be described in detail with reference to the accompanying drawings.

A dry electrode can be manufactured from a dry electrode mixture M and a current collector without a solvent. The dry electrode mixture M can be a mixture including an electrode active material, a conductive material (or conductive additive or conductive agent), and a binder. In addition, the dry electrode mixture M can further include an additive.

The dry electrode can be a cathode or an anode. In some implementations, when a cathode is manufactured, the electrode active material can include a cathode active material. As a non-limiting example, the cathode active material can include LCO (LiCoO₂), NCM (Li(Ni,Co,Mn)O₂), NCA (Li(Ni,Co,Al)O₂), LMO (LiMnO₄), LFP (LiFePO₄), or sulfur.

In some implementations, when an anode is manufactured, the electrode active material can include an anode active material. For example, the anode active material can include natural graphite, artificial graphite, mesocarbon microbeads (MCMB), or a silicon-based active material.

The conductive material can include a carbon-based conductive material. For example, the conductive material can include carbon black, acetylene black, carbon fibers, or carbon nanotubes.

The binder can include polyvinylidene fluoride (PVDF), polytetrafluoroethylene (PTFE), or a copolymer including the same.

As the additive, a solid polymer electrolyte, such as poly(ethylene oxide) (PEO), or an oxide-based or sulfide-based solid electrolyte component can be used.

The dry electrode material can include 70 wt % to 99.9 wt % of the electrode active material, 0.1 wt % to 20 wt % of the conductive material, and 0.1 wt % to 20 wt % of the binder. For instance, the additive can be added at a ratio of 0 to 20 wt %.

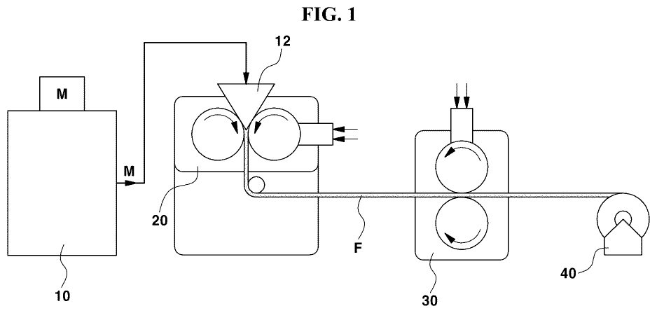

As shown in FIG. 1, a dry electrode mixture M is manufactured into a dry electrode film F through a series of film forming processes in which heat and pressure are applied. A dry electrode manufacturing system according to one implementation of the present disclosure can include a mixer 10 and a roll press 20.

In some implementations, the dry electrode mixture M including an electrode active material, a conductive material, and a binder is mixed by the mixer 10 at a predetermined speed for a predetermined time. As a non-limiting example, the dry electrode mixture M can be prepared by a high-shear mixer using rotation, a fluidized mixer using air, or the like, and the predetermined time and speed can be adjusted by changing the rotational speed and operating time of the mixer 10.

The dry electrode mixture M mixed in the mixer 10 can be formed into the dry electrode film F by a film forming device. Specifically, the dry electrode mixture M mixed in the mixer 10 can be directed to a feeder 12 or the roll press 20. The dry electrode mixture M can be primarily pressed into the dry electrode film F by the roll press 20. The roll press 20 rotates while providing pressing force to form the dry electrode mixture M into the dry electrode film F. The dry electrode film F that was primarily formed from the dry electrode mixture M can be additionally pressed by a downstream roll press 30, and the thickness of the dry electrode film F can be adjusted through pressing. Thereafter, the dry electrode film F is wound by a winder 40. Then, the dry electrode film F can be bonded or laminated onto a current collector, thereby manufacturing a dry electrode.

For example, the dry electrode mixture M can refer to a powder in which the electrode active material, the conductive material, and the binder are appropriately mixed and dispersed through the mixer 10, and which is in a state of being formable into the dry electrode film F when pressed by the film forming device, i.e., the roll press 20.

The dry electrode mixture M can be considered being appropriately mixed and dispersed through fibrillization of the binder and complexation of the electrode active material and the conductive material. In other words, in order to manufacture a dry electrode in the form of a free-standing film, the complexation of the electrode active material and the conductive material plays an important role along with the fibrillization of the binder. The complexation of the electrode active material and the conductive material can be explained as coating of the surface of the electrode active material with the conductive material. The coating of the electrode active material with the conductive material can be achieved by a high shear force applied by the mixer 10. The fibrillization of the binder can be explained as the binder being stretched thinly and long by the high shear force from the mixer 10 to connect the complexed electrode active material and conductive material into a network. The fibrillization of the binder can particularly allow the binder to serve as a structure so that the manufactured dry electrode can become a free-standing film.

In the manufacturing process of the dry electrode, the fibrillization of the binder and the complexation of the electrode active material and the conductive material can be achieved in the mixing process by the mixer 10. That is, the conductive material is complexed with the electrode active material by mixing the electrode active material and the conductive material. The network can be formed in the dry electrode mixture by adding the binder to the complexed particles to fibrillized the binder.

That is, uniformly dispersing the electrode active material, the conductive material, and the binder during manufacture of the battery electrode is important in both wed and dry electrodes. Unlike the dry electrode process, in the wet electrode process, the binder, which is a polymer, exists in a dissolved state in a slurry, and thus it is relatively easy to secure dispersibility in the mixing process. This is different in the case of the dry electrode, where particle sizes and specific gravities differ in the electrode active material, the conductive material, and the binder. Therefore, it can be difficult to maintain dispersibility during transportation of the dry electrode mixture M prepared by mixing the electrode active material, the conductive material, and the binder through the dry process or during a feeding process for manufacturing the dry electrode film F.

For example, the dry electrode mixture M obtained through the above-described mixing process can pass through a series of transport processes to manufacture the dry electrode. Transport processes from the mixer 10 to the feeder 12 in FIG. 1 can be an example of the series of transport processes. In addition, the dry electrode mixture M can be stored for a designated period of time before manufacture of the dry electrode. For example, the dry electrode mixture M mixed in the mixer 10 may not be immediately formed into the film and can be transported to a separate storage to be stored. In this situation, it is difficult for the dry electrode mixture M to maintain dispersibility due to the characteristics of the materials, but there is almost no technology to determine the state of the dry electrode mixture M, such as dispersibility, after transport or storage.

Accordingly, the present disclosure provides a method capable of simply and accurately evaluating a dispersibility of a dry electrode mixture at any point in time.

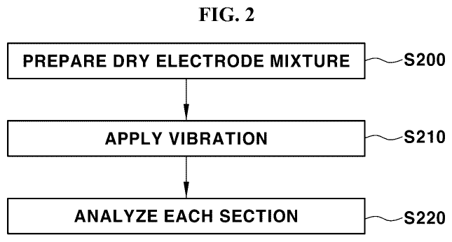

For example, as shown in FIG. 2, a dispersibility evaluation of a dry electrode mixture can be performed by sampling the dry electrode mixture to be evaluated at operation S200, applying vibration to the sampled dry electrode mixture to be evaluated at operation S210, and analyzing the dry electrode mixture to be evaluated to which vibration has been applied at operation S220.

For example, the dry electrode mixture to be evaluated can be a mixture that is prepared by mixing under predetermined mixing conditions during mixing to have an appropriate dispersibility. In some cases, the dry electrode mixture to be evaluated can be a mixture in which it is not known whether the mixture has an appropriate dispersibility because it is prepared by mixing under unknown mixing conditions. In some cases, the dry electrode mixture to be evaluated can be a mixture in which it is not known whether the dispersibility of the mixture is maintained by transport or storage.

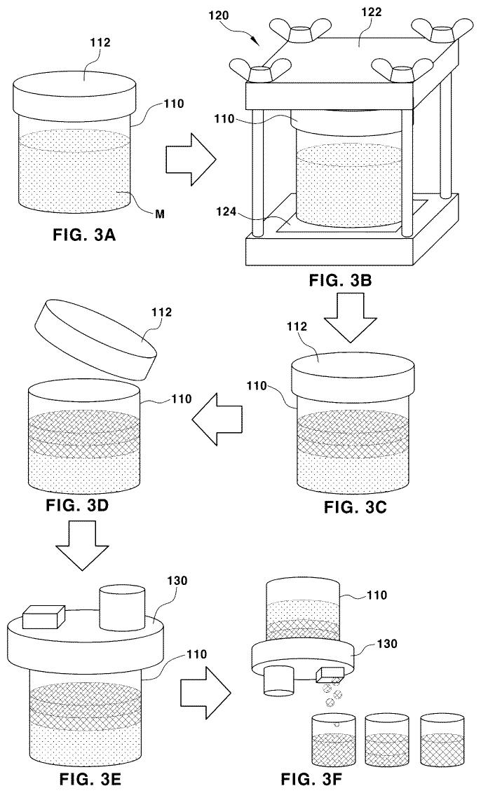

With additional reference to FIGS. 3A to 3F, a dry electrode mixture to be evaluated is sampled. A sample mixture Mₑ, which is the sampled dry electrode mixture, can be sampled in a predetermined amount in FIG. 3A. The sample mixture Mₑ to be evaluated can be accommodated in a container 110. The container 110 can include a detachable lid 112. The dry electrode mixture to be evaluated or the sample mixture Mₑ will be indicated by reference symbol Mₑ to be distinguished from the dry electrode mixture M.

The container 110 is configured such that vibration is applied thereto. In some implementations, vibration can be applied to the container 110 by a vibration application device 120. In some implementations, the vibration application device 120 can include a jig 122 and a vibration application portion 124. The jig 122 is configured to fix the container 110. The vibration application portion 124 can be, as a non-limiting example, an electromagnet driver.

The vibration application device 120 can apply vibration to the container 110 for a predetermined time in FIG. 3B. In some implementations, the vibration application device 120 can apply vibration to the container 110 at a predetermined vibration intensity. As a non-limiting example, the predetermined time or the predetermined vibration intensity can be determined through experiments. For example, the vibration can be applied to the container 110 until two or more layers (i.e., height levels) are formed/divided in the sample mixture in the container.

When application of vibration by the vibration application device 120 is completed, the container 110 can be separated from the jig 122. Due to the Brazil nut effect by vibration, the sample mixture Mₑ in the container 110 can be separated into layers depending on particle size in FIG. 3C.

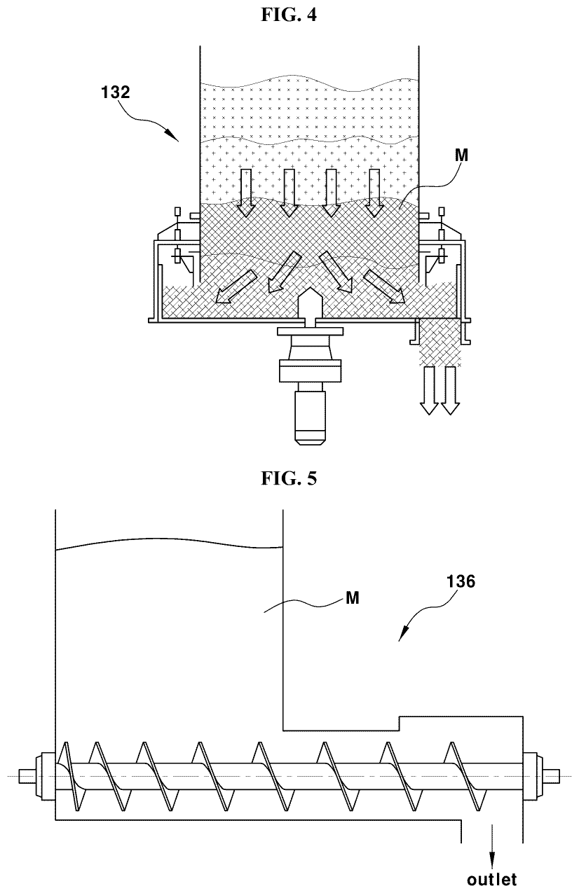

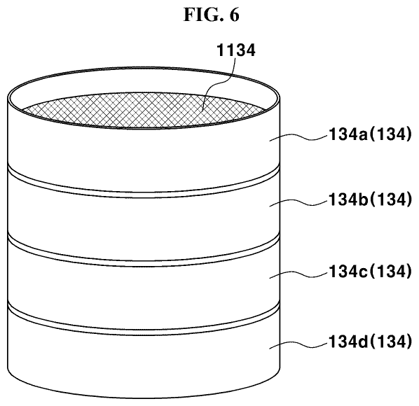

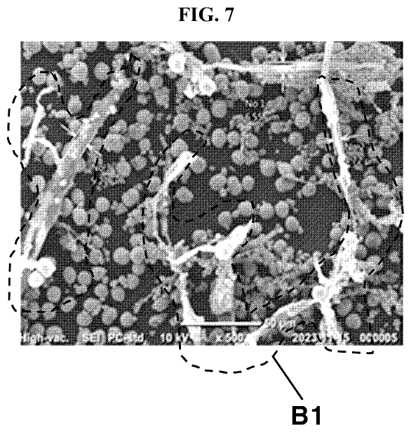

The lid 112 is separated from the container 110 in FIG. 3D, and a feeder 130 is mounted on the container in FIG. 3E. The feeder 130 can be a first-in, first-out feeder or a mass flow feeder configured to sequentially discharge the sample mixture Mₑ in the container 110. In some implementations, as shown in FIG. 4, the feeder 130 can include a circle feeder 132. In some examples, as shown in FIG. 5, the feeder 130 can include a screw feeder 136.

The sample mixture Mₑ is divided into equal amounts through the feeder 130 and distributed into analysis holders for analysis in FIG. 3F. As shown in FIG. 6, in some implementations, sieves 134 can be used instead of the container 110, and the feeder 130 can be omitted. The sieves 134 can include a plurality of sieves 134a, 134b, 134c, and 134d. Each sieve 134a, 134b, 134c, or 134d can include a net 1134. The nets 1134 of the sieves 134a, 134b, 134c, and 134d are configured to have different mesh sizes. In some examples, the mesh sizes of the nets 1134 of the sieves 134a, 134b, 134c, and 134d become gradually smaller in order from the sieve 134a to the sieve 134d. The sieves 134 can be directly mounted in the jig 122 of the vibration application device 120, and vibration can be applied to the sieves 134 by the vibration application device 120. The particle size of the sample mixture Mₑ remaining in each sieve 134a, 134b, 134c, or 134d decreases in order from the sieve 134a to the sieve 134d. The sample mixture Mₑ in each sieve 134a, 134b, 134c, or 134d can be sampled and analyzed.

The sample mixture Mₑ contained in each analysis holder or the sample mixture Mₑ in each sieve 134a, 134b, 134c, or 134d can be analyzed. A dispersibility can be evaluated through comparative analysis of the sample mixture Mₑ contained in each analysis holder or the sample mixture Mₑ in each sieve 134a, 134b, 134c, or 134d. An appropriate dispersibility can refer to satisfying a predetermined dispersibility standard, and an inappropriate dispersibility or poor dispersibility can refer to not satisfying the predetermined dispersibility standard. In some implementations, the dispersibility of the sample mixture Mₑ can be evaluated through visual inspection. In some implementations, the dispersibility of the sample mixture Mₑ contained in each analysis holder or the sample mixture Mₑ in each sieve 134a, 134b, 134c, or 134d can be evaluated through an image captured by an imaging device such as a scanning electron microscope (SEM). In some implementations, the dispersibility of the sample mixture Mₑ contained in each analysis holder or the sample mixture Mₑ in each sieve 134a, 134b, 134c, or 134d can be evaluated based on measured electrical conductivity. In some implementations, the dispersibility of each sample mixture Mₑ can be evaluated through an analysis method, such as thermogravimetric analysis (TGA), carbon/sulfur determinator (CS) analysis, or combustion ion chromatography.

In the visual inspection, if there is a color difference between the layers of the sample mixture Mₑ contained in the container 110 or the sample mixtures Mₑ contained in the respective sieves 134a, 134b, 134c, and 134d, the corresponding sample mixture Mₑ can be determined to be not properly dispersed.

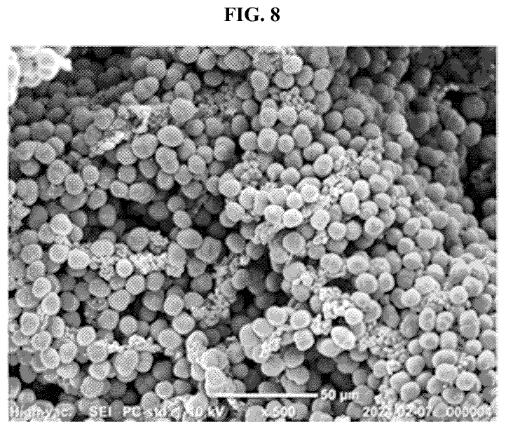

As shown in FIGS. 7 and 8, an SEM image of the sample mixture Mₑ contained in each analysis holder or the sample mixture Mₑ contained in each sieve 134a, 134b, 134c, or 134d can be obtained. In some examples, whether the dispersibility of the sample mixture Mₑ is appropriate can be determined depending on the size of the binder observed in the SEM image. As shown in FIG. 7, where a large binder particle B1 is observed in the SEM image, the corresponding sample mixture Mₑ can be determined to be defective because the binder is separated by vibration. In some examples, as shown in FIG. 8, where an image in which the binder is not separated even by vibration is observed, the corresponding sample mixture Mₑ can be determined to be normal. The SEM image analysis can be performed on sample mixtures Mₑ in all the analysis holders or all the sieves 134a, 134b, 134c, and 134d, and whether the dispersibilities of the corresponding sample mixtures Mₑ are appropriate can be determined.

The dispersibility of the sample mixture Mₑ can be evaluated based on measured electrical conductivity. For example, whether the dispersibility of the sample mixture Mₑ is appropriate can be determined based on the average electrical conductivity of the sample mixture Mₑ. If a difference between the average electrical conductivities of the sample mixture Mₑ is greater than or equal to a predetermined value from each other, the sample mixture Mₑ can be determined not to be appropriately dispersed. The measurement of the electrical conductivity can be performed for each of the sample mixtures Mₑ contained in all the analysis holders or each of the sample mixtures Mₑ contained in all the sieves 134a, 134b, 134c, and 134d.

In some implementations, the average electrical conductivity can be measured by a method. For example, during mixing by the mixer 10, a predetermined amount of a dry electrode mixture is sampled at regular time intervals (for example, every 1 minute, 5 minutes, 10 minutes, or the like), and the electrical conductivity of the sample mixture is measured. At each time interval, the electrical conductivity is measured while applying a constant load (for example, force or pressure) to the sample mixture. The electrical conductivity is measured under each load while increasing the magnitude of the load (e.g., increasing the magnitude of the load incrementally) (e.g., the electrical conductivity can be measured at each force while increasing the magnitude of force, such as 1 kilonewton (kN), 2 kN, 3 kN, etc., so that 20 force values from 1 kN to 20 kN can be applied). For example, the electrical conductivity can be measured by an electrical conductivity measurement device, such as a 4-point probe. Pressure can be uniformly applied to the sample mixture by a pressing device located above the mixture. The average value of the electrical conductivities measured at the respective loads at each time interval is used as the average electrical conductivity at each time interval.

The dispersibility of the sample mixture Mₑ can be evaluated by analyzing the contents of the binder and the conductive material using thermogravimetric analysis (TGA), carbon/sulfur determinator (CS) analysis, or combustion ion chromatography. Thermogravimetric analysis (TGA) is an analysis method in which changes in mass are measured as a function of temperature. The content of each component is analyzed based on the amount of mass decreased or increased depending on temperature. Carbon/sulfur determinator (CS) analysis is an analysis method in which the contents of carbon and sulfur in a material are detected.

If the content of the binder or the conductive material measured through the content analysis of the binder and the conductive material using the above analysis method is not within a set range of a predetermined target content, the corresponding sample mixture Mₑ can be determined to be defective. For example, if the content of the binder or the conductive material measured through the above analysis method differs from a target content by about 10 percent, the corresponding sample mixture Mₑ can be determined not to be appropriately dispersed. For example, if the content of the binder or the conductive material of the sample mixture Mₑ contained in any one of the analysis holders is not within the set range of the predetermined target content, the corresponding sample mixture Mₑ can be determined not to be appropriately dispersed.

As described above, the mixing process in the dry electrode process is a process of mixing the electrode active material, the conductive material, the binder, etc. to ensure uniform distribution. Even if the dispersibility of the mixture is confirmed right after the mixing process, the dispersibility can be changed due to external conditions, such as vibration or air mixing, during transportation or storage of the mixture. The change in the dispersibility can cause a defect of the dry electrode film in the film forming process and cause the dry electrode film to have a composition that is different from the design specifications locally, which can lower safety of battery cells. The present disclosure can provide dry electrode mixture evaluation technology capable of evaluating whether the dispersibility of a dry electrode mixture immediately after mixing is stably maintained thereafter.

In some implementations, the present disclosure provides a method of evaluating a dry electrode mixture capable of accurately evaluating a dispersibility of a dry electrode mixture regardless of time, and a method of manufacturing a dry electrode including the same.

In addition, the present disclosure provides a method of evaluating a dry electrode mixture that facilitates securing of quality of a dry electrode, and a method of manufacturing a dry electrode including the same.

The effects of the present disclosure are not limited to the above-mentioned effects, and other effects not mentioned herein will be clearly understood by one having ordinary skill in the art from the above description.

The present disclosure described above is not limited to the above-described example implementations and the accompanying drawings, and it will be apparent to one having ordinary skill in the art to which the present disclosure pertains that various substitutions, modification, and changes are possible within a scope that does not depart from the technical spirit of the present disclosure.

What is claimed is:

1. A method for evaluating a dry electrode mixture, the method comprising:
applying vibration to the dry electrode mixture for a predetermined time; and
determining a dispersibility of the dry electrode mixture based on an analysis of the dry electrode mixture after applying the vibration to the dry electrode mixture.

2. The method of claim 1, wherein determining the dispersibility comprises:
based on presence of a color difference between height levels in the dry electrode mixture formed after applying the vibration to the dry electrode mixture, determining that the dispersibility of the dry electrode mixture does not satisfy a predetermined standard.

3. The method of claim 1, wherein applying the vibration to the dry electrode mixture comprises applying the vibration to the dry electrode mixture until the dry electrode mixture is divided into two or more layers, and
wherein the dispersibility of the dry electrode mixture is determined based on a comparison between the two or more layers of the dry electrode mixture.

4. The method of claim 3, further comprising:
providing the dry electrode mixture divided into the two or more layers through a mass flow feeder.

5. The method of claim 3, wherein determining the dispersibility comprises:
obtaining scanning electron microscope images of the two or more layers; and
determining the dispersibility of the dry electrode mixture based on the scanning electron microscope images.

6. The method of claim 5, wherein determining the dispersibility comprises:
determining a size of a binder of the dry electrode mixture in the scanning electron microscope images; and
based on determining that the size of the binder of the dry electrode mixture is greater than a predetermined size, determining that the dispersibility of the dry electrode mixture does not satisfy a predetermined standard.

7. The method of claim 3, wherein determining the dispersibility comprises:
measuring electrical conductivities of the two or more layers; and
determining the dispersibility of the dry electrode mixture based on the measured electrical conductivities of the two or more layers.

8. The method of claim 7, wherein determining the dispersibility comprises:
based on determining that a difference between the measured electrical conductivities of the two or more layers is greater than or equal to a predetermined value, determining that the dispersibility of the dry electrode mixture does not satisfy a predetermined standard.

9. The method of claim 3, wherein determining the dispersibility comprises:
determining contents of the dry electrode mixture in the two or more layers; and
determining the dispersibility of the dry electrode mixture based on a comparison between the contents of the dry electrode mixture in the two or more layers.

10. The method of claim 9, wherein determining the dispersibility comprises:
based on determining that the contents of the dry electrode mixture in any one of the two or more layers is not within a set range of a predetermined target content, determining that the dispersibility of the dry electrode mixture does not satisfy a predetermined standard.

11. The method of claim 9, wherein determining the contents of the dry electrode mixture comprises performing thermogravimetric analysis (TGA), carbon/sulfur determinator (CS) analysis, or combustion ion chromatography.

12. The method of claim 9, wherein determining the contents of the dry electrode mixture comprises determining a content of a binder or a conductive material in the dry electrode mixture.

13. The method of claim 1, further comprising:
before applying the vibration to the dry electrode mixture, providing the dry electrode mixture to a plurality of sieves having different mesh sizes,
wherein applying the vibration to the dry electrode mixture comprises applying the vibration to the plurality of sieves.

14. The method of claim 1, further comprising:
before applying the vibration to the dry electrode mixture, preparing the dry electrode mixture by mixing a dry electrode active material, a conductive material, and a binder.

15. The method of claim 1, further comprising:
based on determining that the dispersibility of the dry electrode mixture satisfies a predetermined standard, forming the dry electrode mixture into a dry electrode film.

16. A method for manufacturing a dry electrode, comprising:
preparing a dry electrode mixture;
applying vibration to the dry electrode mixture for a predetermined time;
determining a dispersibility of the dry electrode mixture based on an analysis of the dry electrode mixture after applying the vibration to the dry electrode mixture; and
based on determining that the dispersibility of the dry electrode mixture satisfies a predetermined standard, forming the dry electrode mixture into a dry electrode film.

17. The method of claim 16, wherein determining the dispersibility comprises:
analyzing at least one of a color of the dry electrode mixture, a scanning electrode microscope image of the dry electrode mixture, an electrical conductivity of the dry electrode mixture, a content of the dry electrode mixture, or a combination thereof.

18. The method of claim 16, wherein applying the vibration to the dry electrode mixture comprises applying the vibration to the dry electrode mixture until the dry electrode mixture is divided into two or more layers, and
wherein the dispersibility of the dry electrode mixture is determined based on a comparison between the two or more layers of the dry electrode mixture.

19. The dry electrode manufactured by the method of claim 16.

20. A battery comprising the dry electrode manufactured by the method of claim 16.
